(19) United States
(12) Patent Application Publication
(10) Pub. No.: US 2026/0255157 A1
(43) Pub. Date: Aug. 27, 2026

(54) METHOD AND APPARATUS FOR MANAGING INTERNET-OF-THINGS DEVICES

(71) Applicant: Beijing Xiaomi Mobile Software Co., Ltd., Beijing (CN)

(72) Inventor: Jinhua WU, Beijing (CN)

(21) Appl. No.: 18/875,927

(22) PCT Filed: Jun. 24, 2022
(86) PCT No.: PCT/CN2022/101334

§ 371 Date: Dec. 17, 2024

(51) Int. Cl. H04W 12/02; H04W 12/06; H04W 48/16; H04W 64/00

(52) U.S. Cl. CPC H04W 12/02; H04W 12/06; H04W 48/16; H04W 64/00

(57) ABSTRACT

A method for managing IoT device is executed by an application function (AF) network element. The method includes: receiving an Internet of Things (IoT) device management request sent by a user equipment (UE), wherein the IoT device management request includes data for operating a location service (LCS) privacy profile of an IoT device in a unified data management (UDM) network element; and sending the data and an operation message to the UDM network element through a network exposure function (NEF) network element, wherein the operation message is configured to notify the UDM network element to operate the LCS privacy profile according to the data.

### CROSS REFERENCE

The present application is a U.S. national phase application of International Application No. PCT/CN2022/101334, filed on Jun. 24, 2022, the entire content of which incorporated herein by reference.

### TECHNICAL FIELD

The present disclosure relates to the field of mobile communication technology, and in particular to a method and device for managing Internet of Things devices.

### BACKGROUND

Mobile network communication systems provide location service functions for many application scenarios to meet users' needs for device location information. For users with Internet of Things (IoT) devices, the location of IoT devices can be obtained through the Location Service (LCS) client in the User Equipment (UE).

### SUMMARY

A first aspect embodiment of the present disclosure provides an Internet of Things device management method, which is executed by an application function (AF) network element, and the method includes: receiving an Internet of Things (IoT) device management request sent by a user equipment (UE), wherein the IoT device management request includes data for operating a location service (LCS) privacy profile of an IoT device in a unified data management (UDM) network element; and sending the data and an operation message to the UDM network element through a network exposure function (NEF) network element, wherein the operation message is configured to notify the UDM network element to operate the LCS privacy profile according to the data.

A second aspect embodiment of the present disclosure provides an Internet of Things device management method, which is executed by a unified data management (UDM) network element, and the method includes: receiving, through a network exposure function (NEF) network element, data and an operation message sent by an application function (AF) network element for operating a location service (LCS) privacy profile of an IoT device in the UDM network element; and operating the LCS privacy profile based on the data in response to the operation message.

A third aspect embodiment of the present disclosure provides an Internet of Things device management method, which is executed by a user equipment (UE), and the method includes: sending an Internet of Things (IoT) device management request, wherein the IoT device management request includes data for operating a location service (LCS) privacy profile of an IoT device in a unified data management (UDM) network element.

A fourth aspect embodiment of the present disclosure provides an Internet of Things device management method including: sending, by a user equipment (UE), an Internet of Things IoT device management request to an application function (AF) network element, wherein the IoT device management request includes data for operating a location service (LCS) privacy profile of an IoT device in a unified data management (UDM) network element; sending, by the AF network element the data and an operation message to the UDM network element through a network exposure function (NEF) network element; receiving, by the UDM network element, the data and the operation message through the NEF network element; and operating, by the UDM network element, the LCS privacy profile according to the data in response to the operation message.

A fifth aspect embodiment of the present disclosure provides an apparatus for managing IoT device, applied to an application function (AF) network element and including: a receiving module, configured to receive an Internet of Things (IoT) device management request sent by a user equipment (UE), wherein the IoT device management request includes data for operating a location service (LCS) privacy profile of an IoT device in a unified data management (UDM) network element; and a sending module, configured to send the data and an operation message to the UDM network element through a network exposure function (NEF) network element, wherein the operation message is configured to notify the UDM network element to operate the LCS privacy profile according to the data.

A sixth aspect embodiment of the present disclosure provides an apparatus for managing IoT device, applied to a unified data management (UDM) network element and including: a receiving module, configured to receive, through a network exposure function (NEF) network element, data and an operation message sent by an application function (AF) network element for operating a location service (LCS) privacy profile of an IoT device in the UDM network element; and a configuring module, configured to operate the LCS privacy profile based on the data.

A seventh aspect embodiment of the present disclosure provides an apparatus for managing IoT device, applied to a user equipment (UE) and including: a sending module, configured to send an Internet of Things (IoT) device management request, wherein the IoT device management request includes data for operating a location service (LCS) privacy profile of an IoT device in a unified data management (UDM) network element.

An eighth aspect embodiment of the present disclosure provides a communication system, including a user equipment (UE), an application function (AF) network element, a unified data management (UDM) network element, and a network exposure function (NEF) network element, wherein: the UE sends an Internet of Things (IoT) device management request to the AF network element, wherein the IoT device management request includes data for operating a location service (LCS) privacy profile of an IoT device in the UDM network element; the AF network element sends the data and an operation message to the UDM network element through the NEF network element; the UDM network element receives the data and the operation message through the NEF network element; and the UDM network element operates the LCS privacy profile according to the data in response to the operation message.

A ninth aspect embodiment of the present disclosure provides a communication device, including: a transceiver; a memory; and a processor, connected to the transceiver and the memory respectively, configured to control wireless signal reception and transmission of the transceiver by executing computer executable instructions on the memory, and capable of implementing the Internet of Things device management method according to the above first aspect embodiment or the second aspect embodiment or the third aspect embodiment.

A tenth aspect embodiment of the present disclosure provides a computer storage medium, wherein the computer storage medium is stored with computer executable instructions; and when the computer executable instructions are executed by a processor, the Internet of Things device management method according to the above first aspect embodiment or the second aspect embodiment or the third aspect embodiment can be implemented.

Additional aspects and advantages of the present disclosure will be given in part in the following description and in part will be obvious from the following description or learned through practice of the present disclosure.

It is to be understood that both the foregoing general description and the following detailed description are exemplary and explanatory only and are not restrictive of the present disclosure.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a schematic diagram of a flow chart of an Internet of Things device management method according to an embodiment of the present disclosure;

FIG. 2 is a schematic diagram of a flow chart of a method for managing an IoT device according to an embodiment of the present disclosure;

FIG. 3 is a schematic diagram of a flow chart of a method for managing an IoT device according to an embodiment of the present disclosure;

FIG. 4 is a schematic diagram of a flow chart of a method for managing an IoT device according to an embodiment of the present disclosure;

FIG. 5 is a schematic diagram of a flow chart of a method for managing an IoT device according to an embodiment of the present disclosure;

FIG. 6 is a schematic diagram of a flow chart of a method for managing an IoT device according to an embodiment of the present disclosure;

FIG. 7 is a schematic diagram of a flow chart of a method for managing an IoT device according to an embodiment of the present disclosure;

FIG. 8 is a block diagram of an IoT device management apparatus according to an embodiment of the present disclosure;

FIG. 9 is a block diagram of an IoT device management apparatus according to an embodiment of the present disclosure;

FIG. 10 is a block diagram of an IoT device management apparatus according to an embodiment of the present disclosure;

FIG. 11 is a block diagram of an IoT device management apparatus according to an embodiment of the present disclosure;

FIG. 12 is a block diagram of an IoT device management apparatus according to an embodiment of the present disclosure;

FIG. 13 is a block diagram of an IoT device management apparatus according to an embodiment of the present disclosure;

FIG. 14 is a schematic diagram of the structure of a communication device provided in an embodiment of the present disclosure; and

FIG. 15 is a schematic diagram of the structure of a chip provided in an embodiment of the present disclosure.

### DETAILED DESCRIPTION

Embodiments of the present disclosure are described in detail below, and examples of the embodiments are shown in the accompanying drawings, wherein the same or similar reference numerals throughout represent the same or similar elements or elements having the same or similar functions. The embodiments described below with reference to the accompanying drawings are exemplary and are intended to be used to explain the present disclosure, and should not be construed as limiting the present disclosure.

Mobile network communication systems provide location service functions for many application scenarios to meet users' needs for device location information. The 3rd Generation Partnership Project (3GPP) standard can support location service functions, allowing users to obtain device locations in many application scenarios such as billing, location-based services, legal interception, emergency calls, navigation, search and positioning. By providing location services, the possible location of a specific mobile device can be identified, which requires the location service function to meet the continuous iteration and development of various location-based services or application functions.

In the standard, the current location of the user terminal can be identified and reported in a standard format (such as geographic coordinates), and users, mobile equipment (Mobile Equipment, ME), network operators, service providers, value-added service providers and for internal operations of the Public Land Mobile Network (PLMN). The location service (LoCation Service, LCS) client in the user equipment (UE) can interact with the Gateway Mobile Location Centre (GMLC) to obtain the location of the device.

The 3GPP provides in specification version TS 23.273 programs for privacy verification and 5GC Mobile Terminated Location Request (5GC-MT-LR) procedures for commercial location services. In this case, the LCS client or AF network element request general network positioning. In this case, it is assumed that the target UE can be identified using the Subscriber Permanent Identifier (SUPI) or the Generic Public Subscription Identifier (GPSI). This process applies to requests from LCS clients or AF network elements for the current location of the target UE, where it is assumed that the location service request may require privacy verification and the LCS client or AF needs to be authorized to use the location service.

For example, the LCS client or AF network element (through the NEF network element) sends a request to the gateway (H) GMLC to obtain the location and moving speed of the target UE, where the target UE can be identified by GPSI or SUPI; the gateway (H) GMLC calls the Nudm_SDM_Get service operation to the UDM of the target UE to obtain the privacy settings of the UE identified by its GPSI or SUPI. The UDM returns the privacy settings of the target UE, and the gateway (H) GMLC checks the LCS privacy profile of the UE . . . . If the target UE is located by the LCS client or AF network element, the (H) GMLC sends a location service response to the LCS client or AF through the NEF network element.

With the continuous evolution of communication technology, more and more users have mobile devices or Internet of Things (IoT) devices. In actual use, there are situations where IoT devices need to be located. However, in the relevant technologies of mobile networks, there is no solution for the owner to track and manage whether the IoT device he owns can be located (or who can locate the IoT device) through the UE he owns.

To this end, the present disclosure proposes an IoT device management method and apparatus, and provides a mechanism for managing users who are allowed to locate IoT devices, thereby enhancing the flexibility and security of the positioning function in the communication system and achieving the purpose of unified configuration and management of devices with positioning authority.

Hereinafter, the IoT device management method and apparatus provided by the present application are introduced in detail in conjunction with the accompanying drawings.

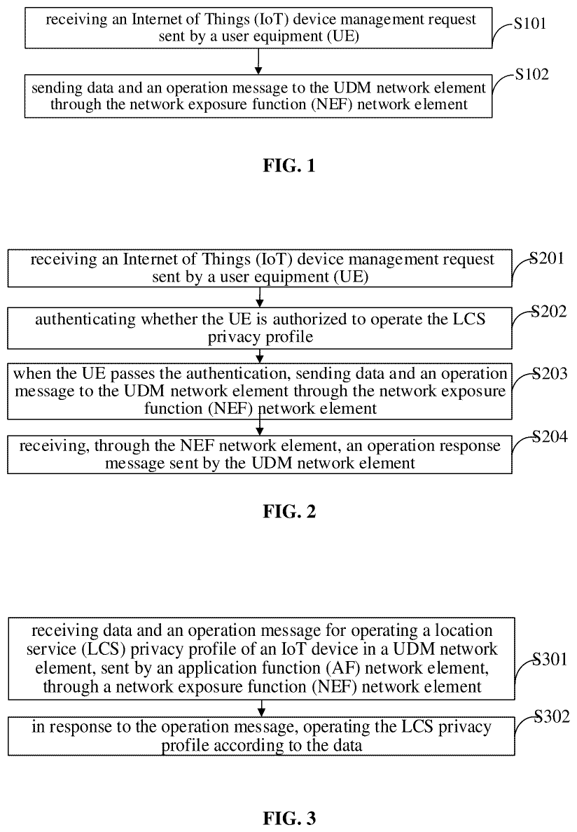

FIG. 1 shows a schematic flow chart of a method for managing IoT device according to an embodiment of the present disclosure. As shown in FIG. 1, the method can be executed by an application function (AF) network element and can include the following steps.

S101, receiving an Internet of Things (IoT) device management request sent by a user equipment (UE).

The IoT device management request includes data for operating the LCS privacy profile of the location service of the IoT device in the unified data management (UDM) network element.

In an embodiment of the present disclosure, the UE can operate or set the LCS privacy profile in the UDM network element through the AF network element. Specifically, the IoT device management request sent by the UE to the AF network element contains data for operating the LCS privacy profile of the location service of the IoT device, which can assist the UDM network element in operating the LCS privacy profile.

It is understandable that the LCS privacy profile may store the identification of devices or users that can locate the IoT device. For example, the Subscriber Permanent Identifier (SUPI) or the Generic Public Subscription Identifier (GPSI) may be used for identification, which is not limited in the present disclosure.

In addition, the device or user capable of locating the IoT device may be an LCS client, an AF network element and/or an LCS client group, or any other subject capable of locating the IoT device, which is not limited in the present disclosure.

S102, sending data and an operation message to the UDM network element through the network exposure function (NEF) network element.

The operation message is used to notify the UDM network element to operate the LCS privacy configuration file according to the data.

In the present disclosure, the AF network element sends data used to operate the LCS privacy profile of the IoT device in the UDM network element to the UDM network element, and sends an operation message to the UDM network element to notify the UDM network element to operate the LCS privacy profile according to the above data, so as to operate the device (or user) that can locate the IoT device according to the operation message and data, authorize or revoke the authority of the device or user to locate the IoT device, and realize unified management of users who can locate IoT devices through UE and AF network elements.

In summary, according to the IoT device management method provided by the present invention, the AF network element receives the IoT device management request sent by the UE, wherein the IoT device management request includes data for operating the location service (LCS) privacy profile of the IoT device in the unified data management (UDM) network element. The AF network element sends the data and operation message to the UDM network element through the NEF network element. The operation message is used to notify the UDM network element to operate the LCS privacy profile according to the data, thereby realizing the operation of setting the LCS privacy profile in the UDM network element by the UE through the AF network element, thereby enhancing the flexibility and security of the positioning function in the communication system, and realizing unified management of users who can locate IoT devices.

FIG. 2 shows a schematic flow chart of a method for managing IoT device according to an embodiment of the present disclosure. The method can be executed by an AF network element, and based on the embodiment shown in FIG. 1, as shown in FIG. 2, the method can include the following steps.

S201: receiving an Internet of Things (IoT) device management request sent by a user equipment (UE).

The IoT device management request includes data for operating the LCS privacy profile of the location service of the IoT device in the unified data management (UDM) network element.

In some embodiments, the data in step S201 includes a list of the user who expects to locate IoT devices, and the operation message is used to notify the UDM network element to configure the LCS privacy profile to allow the user in the user list to locate IoT devices.

In other words, the data sent by the owner of the IoT device through the UE includes which devices the owner allows to locate the IoT device he/she owns, so that the UDM network element can configure the LCS privacy profile to allow these devices to locate the IoT device.

It is understandable that the user list may be that the owner only wants the users in the list to locate the IoT device, while excluding users outside the list from obtaining the location of the IoT device. Alternatively, the owner may also send a list of users who are not allowed to locate the IoT device through the UE. For this, as long as the UE implements the function of controlling who can locate the IoT device through the AF, so as to realize how the owner manages the personnel who can locate the IoT device, which is not limited in the present disclosure.

Specifically, assuming that there is an application for IoT device management in the UE, there is an application client in the UE, which can connect to the application server in the data network through the 3GPP mobile network (or non-3GPP mobile network, not limited in this disclosure). The application acts as an AF and can connect to the 3GPP network through the NEF for IoT device management, such as LCS privacy profile management.

For example, the UE sends an IoT device management request to the AF network element for LCS privacy profile operations (including but not limited to creation, update, and deletion). For example, a profile of an LCS client list is created for the IoT device, which includes users who can locate the IoT device (for example, through GPSI identification). Then, only the UE in this profile can locate the IoT device.

S202, authenticating whether the UE is authorized to operate the LCS privacy profile.

In an embodiment of the present disclosure, after receiving an IoT device management request sent by a UE, the AF network element may authenticate the UE to determine whether the UE is authorized to operate the LCS privacy profile.

Specifically, the AF network element can determine whether the UE that sends the IoT device management request has a subordinate or binding relationship with the IoT device corresponding to the LCS privacy profile that the UE expects to operate. In other words, the AF network element can determine whether the UE has the authority to operate the LCS privacy profile of the IoT device. That is, the AF has (or stores) the information that the above-mentioned application client allows the UE (assuming the identifier is GPSI-1) to manage the IoT device (assuming the identifier is GPSI-2), and this information can be the above-mentioned binding or subordinate relationship.

It should be understood that the subordinate or binding relationship between the UE and the IoT device is not necessarily a one-to-one relationship, but can also be a one-to-many or many-to-many relationship. As long as there is a binding relationship between the UE and the IoT device, the present disclosure does not limit the corresponding relationship.

In an embodiment of the present disclosure, the above data includes: the ID of the UE and the ID of the IoT device that the UE expects to manage.

For example, assuming that a user holds a UE (for example, the UE is a mobile phone) and an IoT device (for example, the IoT device is a BMW car). The owner of the BMW car sends a list of the user who can locate the BMW car, such as family members' mobile phone numbers, to the AF corresponding to the BMW company through the mobile phone. The AF needs to authenticate whether the UE that sends the list has the right to send the list, but does not need to authenticate whether the users in the list have the right to locate the BMW car.

In other words, the AF will receive the ID of the UE and the ID of the BMW car that the UE expects to manage sent by the UE, and determine whether there is a binding or subordinate relationship between the two, thereby determining whether the UE has the right to manage the BMW car.

In an embodiment of the present disclosure, authenticating whether a UE is authorized to operate an LCS privacy profile includes: determining whether there is a binding relationship between the UE's ID and the ID of an IoT device that the UE expects to manage; and when there is a binding relationship, determining that the UE is authenticated.

It should be understood that in the present disclosure, AF can be authenticated in various ways. For example, when a user purchases a vehicle, the AF corresponding to the vehicle is the company that sells the vehicle. The user registers the mobile phone number to the official server by downloading the corresponding application in the UE and interacting through the application. Then, the identity of the user is authenticated by the AF, and the binding relationship between the UE and the vehicle is stored in the AF. It should be understood that the ID of the UE may be a mobile phone number, and the ID of the vehicle may be the license plate number of the vehicle, which may be identified by SUPI or GPSI, and is not limited in the present disclosure.

When the AF network element authenticates the UE as the UE bound to the IoT device, it can be determined that the UE has passed the authentication, that is, has the authority to manage the IoT device.

S203: when the UE passes the authentication, sending data and an operation message to the UDM network element through the network exposure function (NEF) network element.

The operation message is used to notify the UDM network element to operate the LCS privacy configuration file according to the data.

In the present disclosure, when the AF network element determines that the UE has passed the authentication, it sends the data and operation message to the NEF network element, which forwards it to the UDM network element, so that the UDM network element can operate the LCS privacy profile of the IoT device based on the data.

In some embodiments, the IoT device management request also includes an operation type, wherein, when the operation type is create, the operation message is used to notify the UDM network element to create an authorized user list in the LCS privacy profile, and the authorized user list includes the user ID in the user list; or when the operation type is add, the operation message is used to notify the UDM network element to add the user ID in the user list to the authorized user list of the LCS privacy profile; or when the operation type is delete, the operation message is used to notify the UDM network element to delete the user ID in the authorized user list of the LCS privacy profile except the user ID in the user list.

In some optional embodiments, data is associated with a valid time, and the valid time is used to assist the UDM network element in deleting data in the LCS privacy profile that has been stored for longer than the valid time.

For the description and specific details of the above steps S201 and S203, reference may be made to the relevant description and details of the above steps S101 and S102, which will not be repeated here.

S204: receiving, through the NEF network element, an operation response message sent by the UDM network element.

The operation response message is used to indicate whether the UDM successfully operates the LCS privacy profile.

In some optional embodiments, when the operation response message indicates that the operation fails, the operation response message carries the cause for the failure.

In summary, according to the IoT device management method provided by the present disclosure, the AF network element receives the IoT device management request sent by the UE, and authenticates whether the UE is authorized to operate the LCS privacy profile. When the UE passes the authentication of the AF, the AF network element sends the data for operating the LCS privacy profile of the IoT device in the UDM network element and the operation message to the UDM network element through the NEF network element, thereby notifying the UDM network element to operate the LCS privacy profile according to the data, and realizing the operation of setting the LCS privacy profile in the UDM network element by the UE through the AF network element, and enhancing the flexibility and security of the positioning function in the communication system, and unified management of users of the located IoT devices. At the same time, the scheme of the present disclosure can authenticate whether the UE has the authority to manage the IoT device through the AF network element, and enhance the security of the IoT device positioning function, without having to worry about whether other devices that the UE wants to authorize have the right to manage the IoT device, thereby realizing functional isolation between the UE and the UDM network element.

FIG. 3 shows a schematic flow chart of a method for managing IoT device according to an embodiment of the present disclosure. As shown in FIG. 3, the method may be executed by a UDM network element and may include the following steps.

S301, receiving data and an operation message for operating a location service (LCS) privacy profile of an IoT device in a UDM network element, sent by an application function (AF) network element, through a network exposure function (NEF) network element.

In an embodiment of the present disclosure, the UDM network element receives data and an operation message for operating the LCS privacy profile of the IoT device in the UDM network element, which are forwarded by the NEF network element and sent by the AF network element. It is understandable that the LCS privacy profile in the UDM network element may store the identifier of the device or user that can locate the IoT device, for example, the Subscriber Permanent Identifier (SUPI) or the Generic Public Subscription Identifier (GPSI) may be used for identification, which is not limited in the present disclosure.

In addition, the device or user capable of locating the IoT device may be an LCS client, an AF network element or an LCS client group, or any other subject capable of locating the IoT device, which is not limited in the present disclosure.

In other words, UDM can set users who can locate IoT devices in the LCS privacy profile according to the user's configuration, expand the range of devices with positioning function for IoT devices, and uniformly manage users who can locate IoT devices in response to user instructions.

S302, in response to the operation message, operating the LCS privacy profile according to the data.

The operation message is used to notify the UDM network element to operate the LCS privacy profile according to the data.

In an embodiment of the present disclosure, the UDM network element receives data and an operation message for operating the LCS privacy profile of the IoT device in the UDM network element, which are forwarded by the NEF network element and sent by the AF network element. The UDM network element operates the LCS privacy profile according to the above data, operates the device (or user) that can locate the IoT device, authorizes or revokes the authority of the device or user to locate the IoT device, and realizes unified management of users who can locate IoT devices through UE and AF network elements.

In summary, according to the IoT device management method provided by the present invention, the UDM network element receives the data and operation message sent by the AF network element for operating the LCS privacy profile of the IoT device in the UDM network element through the NEF network element, and the UDM network element operates the LCS privacy profile according to the above data, and operates the device (or user) that can locate the IoT device, thereby realizing the operation of setting the LCS privacy profile in the UDM network element by the UE through the AF network element, thereby enhancing the flexibility and security of the positioning function in the communication system, and realizing unified management of users who can locate IoT devices.

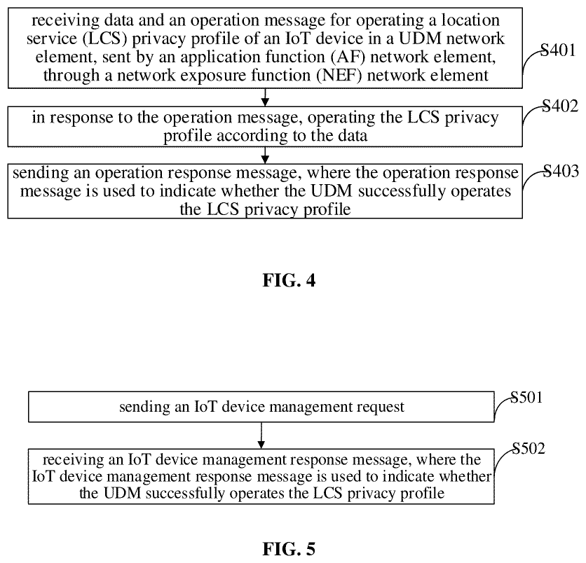

FIG. 4 shows a schematic flow chart of an IoT device management method according to an embodiment of the present disclosure. As shown in FIG. 4, the method may be executed by a UDM network element. Based on the embodiment of FIG. 3, as shown in FIG. 4, the method may include the following steps.

S401, receiving data and an operation message for operating a location service (LCS) privacy profile of an IoT device in a UDM network element, sent by an application function (AF) network element, through a network exposure function (NEF) network element.

The explanation about step S301 in the embodiment shown in FIG. 3 is also applicable to step S401 and will not be repeated here.

In the embodiments of the present disclosure, in some embodiments, the data received by the UDM network element includes a list of users who wish to locate IoT devices, and operating the LCS privacy profile based on the data includes: configuring the LCS privacy profile to allow the user in the user list to locate IoT devices.

In other words, the data sent by the owner of the IoT device through the UE includes which devices the owner wants to be able to locate the IoT device he/she owns, so that the UDM network element can configure the LCS privacy profile to allow these devices to locate the IoT device.

It is understandable that the user list may be that the owner only wants the users in the list to locate the IoT device, while excluding users outside the list from obtaining the location of the IoT device. Alternatively, the owner may also send a list of users who are not allowed to locate the IoT device through the UE. For this, as long as the UE implements the function of controlling who can locate the IoT device through the AF, so as to realize how the owner manages the personnel who can locate the IoT device, it is not limited in the present disclosure.

S402, in response to the operation message, operating the LCS privacy profile according to the data.

The explanation about step S302 in the embodiment shown in FIG. 3 is also applicable to step S402 and will not be repeated here.

Specifically, assuming that there is an application for IoT device management in the UE, there is an application client in the UE, which can connect to the application server in the data network through the 3GPP mobile network (or non-3GPP mobile network, not limited in this disclosure), and the application as AF can connect to the 3GPP network through the NEF for IoT device management, such as LCS privacy profile management. UDM performs IoT device management based on the above data, as described below.

According to the specification version TS 23.273, in the “LCS privacy profile data stored in the UDM for a UE Subscriber”, an external LCS client list (also referred to as the authorized user list in this disclosure) is set, which includes zero or more LCS clients, AFs or LCS client groups (corresponding IDs) as authorized users who can locate IoT devices, that is, only users in the external LCS client list can locate IoT devices.

Specifically, the LCS privacy profile stored in the UDM is set as shown in the following table.

TABLE 1
LCS privacy profile data stored in UDM

| Privacy Profile | | |
|---|---|---|
| Data Type | Presence | UDM data |
| Location Privacy | M | Indication of one of the following mutually exclusive global |
| Indication | | settings: |
| | | Location is disallowed |
| | | Location is allowed (default) |
| | O | Time period when the Location Privacy Indication is valid |
| Call/session | M | For any LCS client or AF not in the external LCS client list |
| Unrelated Class | | or otherwise identified for the Call/session Unrelated |
| | | Class, the following data may be present: |
| | O | One of the following mutually exclusive options: |
| | | Location not allowed (default case) |
| | | Location allowed with notification |
| | | Location with notification and privacy verification; |
| | | location allowed if no response |
| | | Location with notification and privacy verification; |
| | | location restricted if no response |
| | O | Time period when positioning is allowed |
| | O | Geographical area where positioning is allowed |
| | O | Indication that codeword shall be checked in UE or |
| | | one or more codeword values to be checked in GMLC |
| | O | External LCS client list: a list of zero or more LCS clients, |
| | | AFs and LCS Client groups with the following data for |
| | | each entry: |
| | O | One of the following mutually exclusive options: |
| | | Location allowed without notification (default case) |
| | | Location allowed with notification |
| | | Location with notification and privacy verification; |
| | | location allowed if no response |
| | | Location with notification and privacy verification; |
| | | location restricted if no response |
| | O | Time period when positioning is allowed |
| | O | Geographical area where positioning is allowed |

For example, in response to the received data and an operation message, the UDM creates a profile of an LCS client list for the IoT device, which includes users who can locate the IoT device (e.g., through GPSI identification), then only the UEs in this profile can locate the IoT device.

It should be noted that UDM can operate according to the operation type indicated by AF. For example, when the operation type is creation, the operation message is used to notify the UDM network element to create an authorized user list in the LCS privacy profile. The authorized user list includes the user ID in the user list. The UDM network element creates the above-mentioned external LCS client list in the LCS privacy profile based on the operation message and data.

Optionally, when the operation type is add, the operation message is used to notify the UDM network element to add the user ID in the user list to the authorized user list of the LCS privacy profile. The UDM network element then adds the user ID in the user list to the external LCS client list in the LCS privacy profile based on the operation message and data.

Optionally, when the operation type is deletion, the operation message is used to notify the UDM network element to delete the user ID in the authorized user list of the LCS privacy profile except the user ID in the user list. The UDM network element then deletes the user ID in the external LCS client list in the current LCS privacy profile that does not correspond to the received user list based on the operation message and data, so as to keep it completely consistent with the user that the user wants to authorize to access the location of the IoT device.

It is understandable that in some optional embodiments of the present disclosure, the UDM network element can independently determine how to operate the LCS privacy profile based on the received data, so as to maintain complete consistency with the user who wishes to authorize the scope of IoT device location.

For example, configuring the LCS privacy profile to allow the user in the user list to locate IoT devices includes at least one of the following: when there is no authorized user list in the LCS privacy profile, creating an authorized user list in the LCS privacy profile, and the authorized user list includes the user ID in the user list. In other words, the UDM network element receives a user list that a user wants to authorize, but there is no external LCS client list in the current UDM. At this time, the UDM will create an external LCS client list to store the device ID that the user wants to authorize to locate IoT devices.

Optionally, when there is an authorized user list in the LCS privacy profile and the user list contains a user ID that does not appear in the authorized user list, the user ID that does not appear in the authorized user list is added to the authorized user list. In other words, the current UDM stores an external LCS client list, but the user's newly authorized device ID needs to be updated to the UDM. The UDM can add the user ID in the received user list that does not appear in the external LCS client list to the external LCS client list to update the information.

Optionally, when there is an authorized user list in the LCS privacy profile and the authorized user list contains a user ID that is not specified in the user list, the user ID that is not specified in the user list is deleted from the authorized user list. In other words, if the UDM currently stores an external LCS client list, but the device ID that the user no longer wants to authorize needs to be updated to the UDM, the UDM can delete the user ID that was previously stored in the external LCS client list but does not appear in the currently received user list from the external LCS client list to achieve information update.

As an optional embodiment, the above data is associated with an effective time, and the effective time is used to assist the UDM network element in deleting data in the LCS privacy profile whose storage time exceeds the effective time. Therefore, the operation of the UDM to delete the information in the LCS privacy profile can also be: directly delete the data whose storage time exceeds the effective time, without responding to the operation message or performing a list comparison.

S403, sending an operation response message, where the operation response message is used to indicate whether the UDM successfully operates the LCS privacy profile.

When the operation response message indicates that the operation fails, the operation response message carries the cause for the failure.

In summary, according to the IoT device management method provided by the present disclosure, the UDM network element receives the data and an operation message sent by the AF network element through the NEF network element for operating the LCS privacy profile of the IoT device in the UDM network element. The UDM network element operates the LCS privacy profile according to the above data, and operates the device (or user) that can locate the IoT device. By setting an external LCS client list in the UDM and creating, updating or deleting it, unified management of users who locate IoT devices is achieved. At the same time, in the scheme of the present disclosure, the UDM only needs to care about who the user wants to be authorized to locate the IoT device based on the received list, without having to care about whether the UE that sends the list is allowed to manage the IoT device, thereby achieving functional isolation between the UE and the UDM network element.

FIG. 5 shows a schematic flow chart of a method for managing an IoT device according to an embodiment of the present disclosure. The method may be executed by a UE, and the method may include the following steps.

S501, sending an IoT device management request.

The IoT device management request includes data for operating the LCS privacy profile of the location service of the IoT device in the unified data management (UDM) network element.

According to the IoT device management method provided in the present disclosure, the UE sends an IoT device management request to the AF network element, wherein the IoT device management request includes data for operating the location service (LCS) privacy profile of the IoT device in the UDM network element, thereby enabling the UE to manage the LCS privacy profile in the UDM network element and enhancing the flexibility and security of the positioning function in the communication system.

In some embodiments, the data includes the ID of the UE, the ID of the IoT device that the UE wishes to manage, and a list of the user who expects to locate the IoT device, thereby enabling the UE to manage which devices or users can locate the IoT device, thereby achieving unified management of users or devices that can locate IoT devices by the UE.

In some optional embodiments, the method may further include:

S502, receiving an IoT device management response message, where the IoT device management response message is used to indicate whether the UDM successfully operates the LCS privacy profile.

When the IoT device management response message indicates that the operation fails, the IoT device management response message carries the cause for the failure.

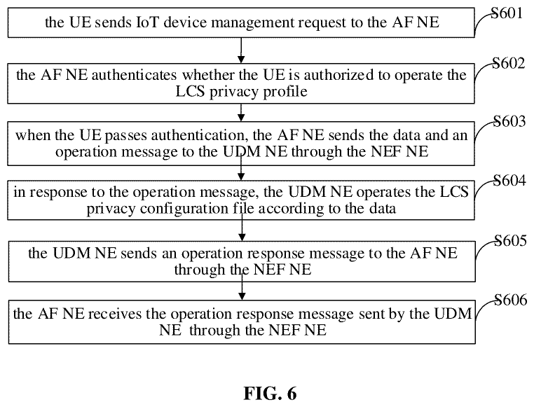

FIG. 6 shows a schematic flow chart of a method for managing IoT device according to an embodiment of the present disclosure. The method may be executed by a communication system, which at least includes a UE, an AF network element, and a UDM network element. As shown in FIG. 6, the method may include the following steps.

S601, the UE sends an IoT device management request to the AF network element.

The IoT device management request includes data for operating the LCS privacy profile of the location service of the IoT device in the unified data management (UDM) network element.

S602: the AF network element authenticates whether the UE is authorized to operate the LCS privacy profile.

S603, when the UE passes the authentication, the AF network element sends data and an operation message to the UDM network element through the NEF network element.

S604: in response to the operation message, the UDM network element operates the LCS privacy configuration file according to the data.

S605, the UDM network element sends an operation response message to the AF network element through the NEF network element.

The operation response message is used to indicate whether the UDM successfully operates the LCS privacy profile.

S606: the AF network element receives the operation response message sent by the UDM network element through the NEF network element.

The above steps S601 to S606 may be performed with reference to the relevant steps in FIGS. 1 to 5, and will not be described in detail herein.

According to the IoT device management method provided by the present invention, through the interaction between the UE, the AF network element and the UDM network element, the AF network element receives the IoT device management request sent by the UE, wherein the IoT device management request includes data for operating the LCS privacy profile of the location service of the IoT device in the unified data management (UDM) network element, and the AF network element sends the data and an operation message to the UDM network element through the NEF network element, and the operation message is used to notify the UDM network element to operate the LCS privacy profile according to the data, thereby realizing the operation of the UE setting the LCS privacy profile in the UDM network element through the AF network element, thereby enhancing the flexibility and security of the positioning function in the communication system, and realizing the unified management of users who can locate IoT devices.

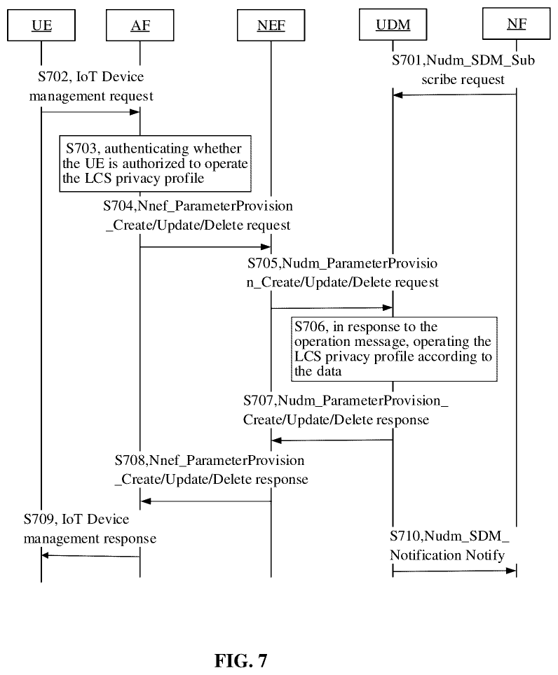

FIG. 7 shows a schematic flow chart of a method for managing IoT device according to an embodiment of the present disclosure. The method may be executed by a communication system, which includes a UE, an AF network element, a UDM network element, a network function (NF) network element, and a network exposure function (NEF) network element. Based on the embodiment of FIG. 6, as shown in FIG. 7, the method may include the following steps.

S701, the NF network element subscribes to the notification of IoT device subscription data update from the UDM network element.

As an example, the NF network element sends a Nudm_SDM_Subscribe request to the UDM network element to subscribe to the notification of IoT device subscription data update.

The NF network element may be, for example, a Gateway Mobile Location Centre (GMLC). The present disclosure does not limit the execution order of this step and other steps in the present disclosure, and this step is similar to the subscription process in the related art and can be executed with reference.

S702, the UE sends an IoT device management request to the AF network element.

As an example, the UE sends an IoT Device management request to the AF network element.

In the present disclosure, the IoT device management request is used for location privacy profile operations (including but not limited to creation, update, and deletion). Specifically, the IoT device management request includes data for operating the location service (LCS) privacy profile of the IoT device in the unified data management (UDM) network element.

For example, if the UE expects that the IoT device can be located by other devices or users, the IoT device management request can create a profile of an external LCS client list (also referred to as an authorized user list in this disclosure) for the managed IoT device (e.g., the IoT device owned by the owner, which is identified by the IoT device GPSI), which includes zero or more LCS clients, AFs or LCS client groups (corresponding IDs) as authorized users who can locate the IoT device, that is, only users in the external LCS client list can locate the IoT device. The created list and/or the data therein can be associated with a valid time.

S703, the AF network element authenticates whether the UE is authorized to operate the LCS privacy profile.

In the present disclosure, the AF network element may check whether the UE sending the request is allowed to manage the IoT device.

Specifically, the AF network element can judge whether the UE that sends the IoT device management request has a subordinate or binding relationship with the IoT device corresponding to the LCS privacy profile that the UE expects to operate. In other words, the AF network element can judge whether the UE has the authority to operate the LCS privacy profile of the IoT device. That is, the AF has (or stores) the information that the above-mentioned application client allows the UE (assuming the identifier is GPSI-1) to manage the IoT device (assuming the identifier is GPSI-2), and this information can be the above-mentioned binding or subordinate relationship.

It should be understood that the subordinate or binding relationship between the UE and the IoT device is not necessarily a one-to-one relationship, but can also be a one-to-many or many-to-many relationship. As long as the UE and the IoT device have a binding relationship, the present disclosure does not limit the corresponding relationship.

In an embodiment of the present disclosure, the above data includes: the ID of the UE and the ID of the IoT device that the UE expects to manage.

For example, suppose a user holds a UE (for example, the UE is a mobile phone) and an IoT device (for example, the IoT device is a BMW car). The owner of the BMW car sends a list of users who can locate the BMW car, such as family members' mobile phone numbers, to the AF corresponding to the BMW company through the mobile phone. The AF needs to authenticate whether the UE that sends the list has the right to send the list, but does not need to authenticate whether the users in the list have the right to locate the BMW car.

In other words, the AF will receive the ID of the UE and the ID of the BMW car that the UE expects to manage sent by the UE, and determine whether there is a binding or subordinate relationship between the two, thereby determining whether the UE has the right to manage the BMW car.

In an embodiment of the present disclosure, authenticating whether a UE is authorized to operate an LCS privacy profile includes: judging whether there is a binding relationship between the UE's ID and the ID of an IoT device that the UE expects to manage; and when there is a binding relationship, determining that the UE is authenticated.

It should be understood that in the present disclosure, AF can authenticate in various ways. For example, when a user purchases a vehicle, the AF corresponding to the vehicle is the company that sells the vehicle. The user registers the mobile phone number to the official server by downloading the corresponding application in the UE and interacting through the application. Then, the identity of the user is authenticated by the AF, and the binding relationship between the UE and the vehicle is stored in the AF. It should be understood that the ID of the UE may be a mobile phone number, and the ID of the vehicle may be the license plate number of the vehicle, which may be identified by SUPI or GPSI, and is not limited in the present disclosure.

When the AF network element authenticates the UE as the UE bound to the IoT device, it can be determined that the UE has passed the authentication, that is, has the authority to manage the IoT device.

S704, when the UE passes the authentication, the AF network element sends data and an operation message to the NEF network element.

As an example, the AF network element sends a Nnef_ParameterProvision_Create/Update/Delete request to the NEF network element.

In a specific example of the present disclosure, the AF network element may provide the received data and operation message to the NEF network element according to the IoT device management request received from the UE. For example, the AF network element indicates the need to create, update or delete data through the operation message, and provides the parameters to be created or updated to the NEF in the Nnef_ParameterProvision_Create or Nnef_ParameterProvision_Update or Nnef_ParameterProvision_Delete request. In the embodiment, the IoT device can be identified by the IoT device GPSI, and the transaction request between the NEF network element and the AF network element can be identified by the transaction reference ID.

For the creation case, the AF network element sends Nnef_ParameterProvision_Create to the NEF network element, and the NEF network element assigns the transaction reference ID to the Nnef_ParameterProvision_Create request. The NEF checks whether the requester is allowed to perform the requested service operation by checking the requester's identifier (i.e., the AF identifier).

In other words, after receiving the message sent by the AF, the NEF network element can authenticate the AF network element and determine whether the AF network element is authorized to send the data.

Depending on the location privacy profile received, for create and update cases, for example, through the Nnef_ParameterProvision_Create or Nnef_ParameterProvision_Update request, the payload includes the following parameters:
Location privacy indication parameters for the “LCS privacy” data subset of the subscription data (see clauses 5.2.3.3.1 and 7.1 of TS 23.273 [51], which are not repeated here), for example, only the UE (identified by GPSI) that exists in the external LCS client list can locate the IoT device (identified by GPSI).

For the deletion case, for example, the AF can request to delete the location privacy profile by sending Nnef_ParameterProvision_Delete to the NEF.

It should be understood that the operation message in the above request, such as creation, update or deletion, can be the creation, update or deletion of the entire list, or the addition or deletion of one or several data in the list.

S705, the NEF network element forwards the data and operation message to the UDM network element.

As an example, the NEF network element sends a Nudm_ParameterProvision_Create/Update/Delete request to the UDM network element.

In an embodiment of the present disclosure, if the AF network element is authorized by the NEF network element to provide parameters (such as the above-mentioned data and an operation message), step S705 is executed, and the NEF network element requests to create, update and store or delete the provided parameters as part of the subscriber data through a Nudm_ParameterProvision_Create, Nudm_ParameterProvision_Update or Nudm_ParameterProvision_Delete request message, which includes the provided data and the NEF reference ID.

S706, in response to the operation message, the UDM network element operates the LCS privacy profile according to the data.

In the present disclosure, for the information sent by the NEF network element in step S705, the UDM network element can determine whether to authorize the AF network element to provide parameters for the IoT device.

If the UDM network element authorizes the AF network element to provide parameters for the IoT device, the UDM network element executes step S706. Specifically, the UDM creates, updates or deletes the provided parameters according to the request of the AF.

The UDM manages IoT devices based on the above data, as described below.

According to the specification version TS 23.273, in the “LCS privacy profile data stored in the UDM for a UE Subscriber”, an external LCS client list (also referred to as the authorized user list in this disclosure) is set, which includes zero or more LCS clients, AFs or LCS client groups (corresponding IDs) as authorized users who can locate IoT devices, that is, only users in the external LCS client list can locate IoT devices.

Specifically, the LCS privacy profile stored in the UDM is set as shown in Table 1 above.

For example, in response to the received data and an operation message, the UDM creates a profile of an LCS client list for the IoT device, which includes users who can locate the IoT device (e.g., through GPSI identification), then only the UEs in the profile can locate the IoT device.

It should be noted that UDM can operate according to the operation type indicated by AF. For example, when the operation type is creation, the operation message is used to notify the UDM network element to create an authorized user list in the LCS privacy profile. The authorized user list includes the user ID in the user list. The UDM network element creates the above-mentioned external LCS client list in the LCS privacy profile based on the operation message and data.

Optionally, when the operation type is add, the operation message is used to notify the UDM network element to add the user ID in the user list to the authorized user list of the LCS privacy profile. The UDM network element then adds the user ID in the user list to the external LCS client list in the LCS privacy profile based on the operation message and data.

Optionally, when the operation type is deletion, the operation message is used to notify the UDM network element to delete the user ID in the authorized user list of the LCS privacy profile except the user ID in the user list. The UDM network element then deletes the user ID in the external LCS client list in the current LCS privacy profile that does not correspond to the received user list based on the operation message and data, so as to keep it completely consistent with the user that the user wants to authorize to access the location of the IoT device.

It can be understood that in some optional embodiments of the present disclosure, the UDM network element can independently determine how to operate the LCS privacy profile based on the received data, so as to maintain complete consistency with the user that the user wants to authorize to access the location of the IoT device.

For example, configuring the LCS privacy profile to allow the user in the user list to locate IoT devices includes at least one of the following: when there is no authorized user list in the LCS privacy profile, creating an authorized user list in the LCS privacy profile, wherein the authorized user list includes user IDs in the user list. In other words, the UDM network element receives a user list that a user wants to authorize, but there is no external LCS client list in the current UDM. At this time, the UDM will create an external LCS client list to store the device IDs that the user wants to authorize to locate IoT devices.

Optionally, when there is an authorized user list in the LCS privacy profile and the user list contains a user ID that does not appear in the authorized user list, the user ID that does not appear in the authorized user list is added to the authorized user list. In other words, the current UDM stores an external LCS client list, but the user's newly authorized device ID needs to be updated to the UDM. The UDM can add the user ID in the received user list that does not appear in the external LCS client list to the external LCS client list to update the information.

Optionally, when there is an authorized user list in the LCS privacy profile and the authorized user list contains a user ID that is not indicated in the user list, the user ID that is not indicated in the user list is deleted from the authorized user list. In other words, if the UDM currently stores an external LCS client list, but the device ID that the user no longer wants to authorize needs to be updated to the UDM, the UDM can delete the user ID that was previously stored in the external LCS client list but does not appear in the currently received user list from the external LCS client list to achieve information update.

As an optional embodiment, the above data is associated with an effective time, and the effective time is used to assist the UDM network element in deleting data in the LCS privacy profile whose storage time exceeds the effective time. Therefore, the operation of the UDM to delete the information in the LCS privacy profile can also be: directly delete the data whose storage time exceeds the effective time, without responding to the operation message or performing a list comparison.

If the AF has no right to provide relevant information, the UDM feeds back a failure response message to the NEF network element, indicating the cause for the failure in the response message, that is, executing step S706.

The parameters (the LCS privacy profile) in this disclosure can be associated with a validity period. The validity period is stored in the UDM and each NF network element (e.g., GMLC). At the expiration of the validity period, each node automatically deletes the parameter without explicit signaling.

The UDM network element responds to the request with a Nudm_ParameterProvision_Create/Update/Delete response. If the process fails, the cause value indicates the reason.

S707, the NEF network element feeds back an operation response message to the AF network element.

If the AF is not authorized to provide parameters, step 707 is executed, and the NEF does not provide the above data and operation message to the UDM network element, but returns an operation response message to the AF network element as a failure response, such as an Nnef_ParameterProvision_Create/Update/Delete response message, to notify the AF network element that the operation failed, and indicates the cause for the failure in the response message.

As an example, the NEF network element sends a Nudm_ParameterProvision_Create/Update/Delete response to the AF network element.

S708, the NEF network element sends an operation response message to the AF network element.

When the operation fails and the NEF network element receives the operation response message sent by the UDM network element, or the NEF does not authorize the AF to provide relevant parameters, the NEF network element sends the operation response message to the AF network element, for example in the form of Nnef_ParameterProvision_Create/Update/Delete Response response request, and carries a cause value in the response message to indicate the cause of the failure.

As an example, the NEF network element sends a Nnef_ParameterProvision_Create/Update/Delete response to the AF network element.

S709, the AF network element sends an operation response message to the UE.

In the present disclosure, when the AF network element receives an operation response message sent by the NEF network element, or the AF network element fails to authenticate the UE, the AF sends an operation response message to the UE, which can be specifically an IoT device management response, for example, in the form of an IoT Device management response, to notify the UE of the operation failure.

As an example, the AF network element sends an IoT Device management response to the UE.

S710, the UDM network element sends IoT device subscription data to the NF network element.

As an example, the UDM network element sends Nudm_SDM_Notification Notify to the NF network element.

In the present disclosure, the UDM network element may notify the subscribed NF (e.g., GMLC) of updated IoT device subscription data, including the location privacy profile, through a Nudm_SDM_Notification Notify message.

It can be understood that the execution order of the above steps S706 and S710 is not limited by the above step numbers, and step S710 can occur at any time after step S705, which is not limited in the present disclosure.

After the NF network element obtains the LCS privacy file of the IoT device, that is, it can be understood that after the above-mentioned step S710, or after “the (H) GMLC invokes a Nudm_SDM_Get service operation towards the UDM of the target UE to get the privacy settings of the UE identified by its GPSI or SUPI; the UDM returns the target UE Privacy setting of the UE; the (H) GMLC checks the UE LCS privacy profile.” in the 5GC Mobile Terminated Location Request (5GC-MT-LR) of the commercial location service in the related art, the NF network element can check the LCS privacy file to determine whether the LCS client is allowed to locate the target IoT device, that is, by judging whether the identifier of the LCS client exists in the authorized user list (external LCS client list).

Therefore, the implementations provided by the present disclosure can achieve:
1) Owners of UE and IoT devices can manage who can find the IoT device through the UE;
2) The LCS privacy profile of IoT devices in UDM is set by the owner's UE through AF;
3) The LCS privacy profile includes devices or users that can locate IoT devices.

In summary, the present disclosure can achieve unified management of users who can locate IoT devices through the owner's UE.

FIGS. 1 to 7 above can be implemented based on the 5GS LCS architecture reference model for non-roaming UEs for reference point identification and will not be described in detail in this disclosure.

In the above embodiments provided by the present application, the method provided by the embodiments of the present application are introduced from the perspectives of network device and user equipment, respectively. In order to implement the functions in the methods provided by the embodiments of the present application, the network device and the user equipment may include hardware structures and software modules, and the functions are implemented in the form of hardware structures, software modules, or hardware structures plus software modules. A function of the functions may be executed in the form of hardware structures, software modules, or hardware structures plus software modules.

Corresponding to the methods for managing the Internet of Things device provided in the above-mentioned embodiments, the present disclosure also provides an apparatus for managing the Internet of Things device. Since the Internet of Things device management apparatus provided in the embodiment of the present disclosure corresponds to the Internet of Things device management methods provided in the above-mentioned embodiments, the implementation method of the Internet of Things device management method is also applicable to the Internet of Things device management apparatus provided in this embodiment, and will not be described in detail in this embodiment.

FIG. 8 is a schematic diagram of the structure of an IoT device management apparatus 800 provided in an embodiment of the present disclosure. The IoT device management apparatus 800 may be used for an AF network element.

As shown in FIG. 8, the apparatus 800 may include a receiving module 810, which is used to receive an Internet of Things IoT device management request sent by a user equipment (UE), wherein the IoT device management request includes data for operating a location service (LCS) privacy profile of an IoT device in a unified data management (UDM) network element; and a sending module 820, which is used to send data and an operation message to the UDM network element through a network exposure function (NEF) network element, wherein the operation message is used to notify the UDM network element to operate the LCS privacy profile according to the data.

According to the Internet of Things device management apparatus provided by the present disclosure, the AF network element receives an IoT device management request sent by the UE, wherein the IoT device management request includes data for operating a location service (LCS) privacy profile of the IoT device in the unified data management (UDM) network element. The AF network element sends the data and an operation message to the UDM network element through the NEF network element, and the operation message is used to notify the UDM network element to operate the LCS privacy profile according to the data, thereby realizing the operation of the UE setting the LCS privacy profile in the UDM network element through the AF network element, thereby enhancing the flexibility and security of the positioning function in the communication system, and realizing unified management of users who can locate IoT devices.

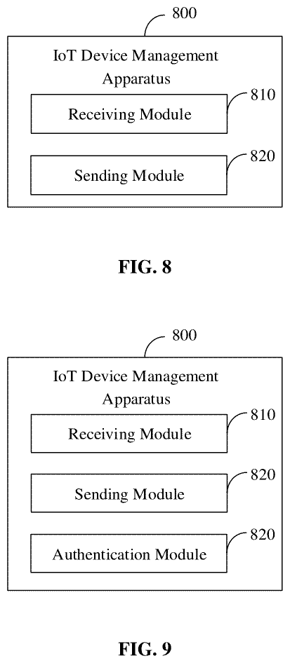

In some embodiments, as shown in FIG. 9, the apparatus 800 further includes: an authentication module 830 for authenticating whether the UE is authorized to operate the LCS privacy profile; wherein the sending module 820 is specifically used for: when the UE passes the authentication, sending data and an operation message to the UDM network element through the NEF network element.

In some embodiments, the data includes: the ID of the UE and the ID of the IoT device that the UE expects to manage; and the authentication module 830 is used to: judge whether there is a binding relationship between the ID of the UE and the ID of the IoT device that the UE expects to manage; and when there is a binding relationship, determine that the UE passes the authentication.

In some embodiments, the data includes a list of users who wish to locate IoT devices, and the operation message is used to notify the UDM network element to configure the LCS privacy profile to allow the user in the user list to locate IoT devices.

In some embodiments, the IoT device management request also includes an operation type, wherein, when the operation type is create, the operation message is used to notify the UDM network element to create an authorized user list in the LCS privacy profile, and the authorized user list includes the user ID in the user list; or when the operation type is add, the operation message is used to notify the UDM network element to add the user ID in the user list to the authorized user list of the LCS privacy profile; or when the operation type is delete, the operation message is used to notify the UDM network element to delete the user ID in the authorized user list of the LCS privacy profile except the user ID in the user list.

In some embodiments, the data is associated with a valid time, and the valid time is used to assist the UDM network element in deleting data in the LCS privacy profile that has been stored for longer than the valid time.

In some embodiments, the receiving module 810 is also used to: receive an operation response message sent by the UDM network element through the NEF network element, the operation response message is used to indicate whether the UDM successfully operates the LCS privacy profile, wherein when the operation response message indicates that the operation failed, the operation response message carries the cause for the failure.

In summary, according to the IoT device management device provided by the present disclosure, the AF network element receives the IoT device management request sent by the UE, and authenticates whether the UE is authorized to operate the LCS privacy profile. When the UE passes the authentication of the AF, the AF network element sends the data for operating the LCS privacy profile of the IoT device in the UDM network element and an operation message to the UDM network element through the NEF network element, thereby notifying the UDM network element to operate the LCS privacy profile according to the data, and realizing the operation of setting the LCS privacy profile in the UDM network element by the UE through the AF network element, and enhancing the flexibility and security of the positioning function in the communication system, and unified management of users of the positioned IoT devices. At the same time, the scheme of the present disclosure can authenticate whether the UE has the authority to manage the IoT device through the AF network element, and enhance the security of the IoT device positioning function, without having to worry about whether other devices that the UE wishes to authorize have the right to manage the IoT device, thereby realizing functional isolation between the UE and the UDM network element.

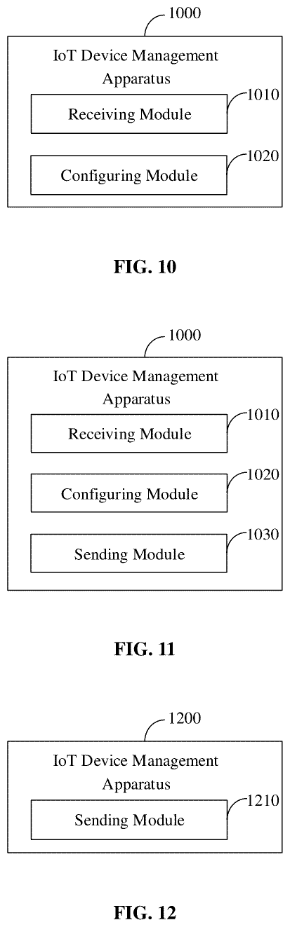

FIG. 10 is a schematic diagram of the structure of an IoT device management apparatus 1000 provided in an embodiment of the present disclosure, wherein the IoT device management apparatus 1000 is applied to a UDM network element.

As shown in FIG. 10, the apparatus 1000 includes: a receiving module 1010, which is used to receive data and an operation message for operating the location service (LCS) privacy profile of the IoT device in the UDM network element sent by the application function (AF) network element through the network exposure function (NEF) network element; and a configuring module 1020, which is used to respond to the operation message and operate the LCS privacy profile according to the data.

According to the Internet of Things device management apparatus provided by the present disclosure, the UDM network element receives data and an operation message sent by the AF network element through the NEF network element for operating the LCS privacy profile of the IoT device in the UDM network element. The UDM network element operates the LCS privacy profile according to the above data, and operates the device (or user) that can locate the IoT device, thereby realizing the operation of setting the LCS privacy profile in the UDM network element by the UE through the AF network element, thereby enhancing the flexibility and security of the positioning function in the communication system, and realizing unified management of users who can locate IoT devices.

In some embodiments, the data includes a list of users who wish to locate IoT devices, and the configuring module 1020 is used to: configure the LCS privacy profile to allow the user in the user list to locate IoT devices.

In some embodiments, the configuring module 1020 is used to: when the authorized user list does not exist in the LCS privacy profile, create an authorized user list in the LCS privacy profile, and the authorized user list includes the user ID in the user list; when the authorized user list exists in the LCS privacy profile and the user list includes a user ID that does not exist in the authorized user list, add the user ID that does not appear in the authorized user list to the authorized user list; when the authorized user list exists in the LCS privacy profile and the authorized user list includes a user ID that is not indicated in the user list, delete the user ID that is not indicated in the user list from the authorized user list.

In some embodiments, the data is associated with an effective time, and the configuring module 1020 is further used to: delete data in the LCS privacy profile whose storage time exceeds the effective time.

In some embodiments, as shown in FIG. 11, the apparatus 1000 further includes: a sending module 1030, configured to send an operation response message, the operation response message being configured to indicate whether the UDM successfully operates the LCS privacy profile, wherein when the operation response message indicates that the operation fails, the operation response message carries the cause of the failure.

According to the IoT device management device provided by the present disclosure, the UDM network element receives the data and an operation message sent by the AF network element through the NEF network element for operating the LCS privacy profile of the IoT device in the UDM network element. The UDM network element operates the LCS privacy profile according to the above data, and operates the device (or user) that can locate the IoT device. By setting an external LCS client list in the UDM and creating, updating or deleting it, unified management of users who locate IoT devices is achieved. At the same time, in the scheme of the present disclosure, the UDM only needs to care about who the user wants to be authorized to locate the IoT device based on the received list, without having to care whether the UE that sends the list is allowed to manage the IoT device, thereby achieving functional isolation between the UE and the UDM network element.

FIG. 12 is a schematic diagram of the structure of an IoT device management apparatus 1200 provided in an embodiment of the present disclosure. The IoT device management apparatus 1200 can be used for a UE.

As shown in FIG. 12, the apparatus 1200 includes: a sending module 1210 for sending an Internet of Things (IoT) device management request, wherein the IoT device management request includes data for operating a location service (LCS) privacy profile of an IoT device in a unified data management (UDM) network element.

According to the IoT device management method provided in the present disclosure, the UE sends an IoT device management request to the AF network element, wherein the IoT device management request includes data for operating the location service (LCS) privacy profile of the IoT device in the UDM network element, thereby enabling the UE to manage the LCS privacy profile in the UDM network element and enhancing the flexibility and security of the positioning function in the communication system.

In some embodiments, the data includes the ID of the UE, the ID of the IoT device that the UE wishes to manage, and a list of users who wish to locate the IoT device.

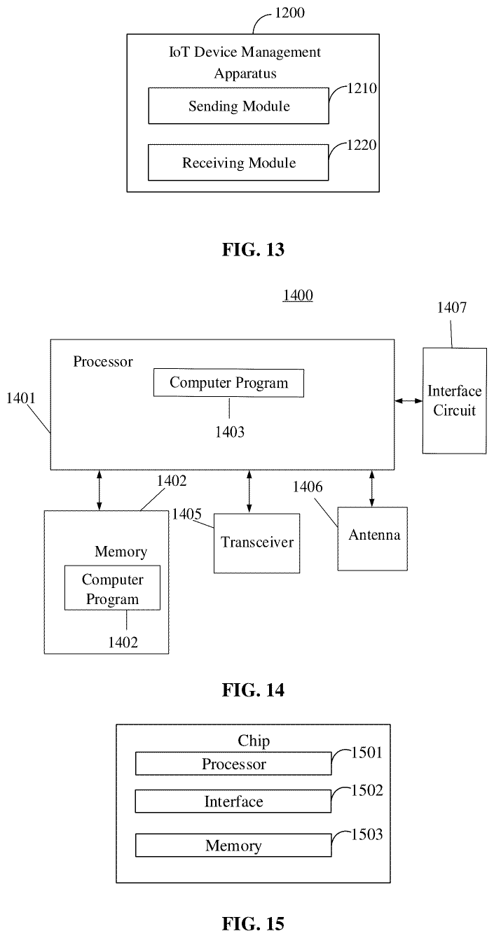

In some embodiments, as shown in FIG. 13, the apparatus 1200 also includes: a receiving module 1220, used to receive an IoT device management response message, the IoT device management response message is used to indicate whether the UDM successfully operates the LCS privacy profile, wherein when the IoT device management response message indicates that the operation failed, the IoT device management response message carries the cause for the failure.

The embodiment of the present disclosure also provides a communication system, which includes the device shown in FIGS. 8-13 above.

Please refer to FIG. 14, which is a schematic diagram of the structure of a communication device 1400 provided in an embodiment of the present application. The communication device 1400 can be a network device, or a user device, or a chip, a chip system, or a processor that supports the network device to implement the above method, or a chip, a chip system, or a processor that supports the user equipment to implement the above method. The device can be used to implement the method described in the above method embodiment, and the details can be referred to the description in the above method embodiment.

The communication device 1400 may include one or more processors 1401. The processor 1401 may be a general-purpose processor or a dedicated processor, etc. For example, it may be a baseband processor or a central processing unit. The baseband processor may be used to process the communication protocol and communication data, and the central processing unit may be used to control the communication device (such as a base station, a baseband chip, a terminal device, a terminal device chip, a DU or a CU, etc.), execute a computer program, and process the data of the computer program.

Optionally, the communication device 1400 may further include one or more memories 1402, on which a computer program 1404 may be stored, and the processor 1401 executes the computer program 1404, so that the communication device 1400 performs the method described in the above method embodiment. Optionally, data may also be stored in the memory 1402. The communication device 1400 and the memory 1402 may be provided separately or integrated together.

Optionally, the communication device 1400 may further include a transceiver 1405 and an antenna 1406. The transceiver 1405 may be referred to as a transceiver unit, a transceiver, or a transceiver circuit, etc., for implementing a transceiver function. The transceiver 1405 may include a receiver and a transmitter, the receiver may be referred to as a receiver or a receiving circuit, etc., for implementing a receiving function; the transmitter may be referred to as a transmitter or a transmitting circuit, etc., for implementing a transmitting function.

Optionally, the communication device 1400 may further include one or more interface circuits 1407. The interface circuit 1407 is used to receive code instructions and transmit the code instructions to the processor 1401. The processor 1401 runs the code instructions to enable the communication device 1400 to perform the method described in the above method embodiment.

In one implementation, the processor 1401 may include a transceiver for implementing receiving and sending functions. For example, the transceiver may be a transceiver circuit, an interface, or an interface circuit. The transceiver circuit, interface, or interface circuit for implementing the receiving and sending functions may be separate or integrated. The above-mentioned transceiver circuit, interface, or interface circuit may be used for reading and writing code/data, or the above-mentioned transceiver circuit, interface, or interface circuit may be used for transmitting or delivering signals.

In one implementation, the processor 1401 may store a computer program 1403, which runs on the processor 1401 and enables the communication device 1400 to perform the method described in the above method embodiment. The computer program 1403 may be fixed in the processor 1401, in which case the processor 1401 may be implemented by hardware.

In one implementation, the communication device 1400 may include a circuit, and the circuit may implement the functions of sending or receiving or communicating in the aforementioned method embodiment. The processor and transceiver described in the present application may be implemented in an integrated circuit (IC), an analog IC, a radio frequency integrated circuit RFIC, a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), etc.

The communication device described in the above embodiments may be a network device or a user device, but the scope of the communication device described in the present application is not limited thereto, and the structure of the communication device may not be limited by FIG. 14. The communication device may be an independent device or may be part of a larger device. For example, the communication device may be:
(1) An independent integrated circuit IC, or chip, or chip system or subsystem;
(2) A set of one or more ICs, optionally, the IC set may also include a storage component for storing data or computer programs;
(3) ASIC, such as modem;
(4) Modules that can be embedded in other devices;
(5) Receivers, terminal devices, intelligent terminal devices, cellular phones, wireless devices, handheld devices, mobile units, vehicle-mounted devices, network devices, cloud devices, artificial intelligence devices, etc.; and
(6) Others

For the case where the communication device can be a chip or a chip system, please refer to the schematic diagram of the chip structure shown in FIG. 15. The chip shown in FIG. 15 includes a processor 1501 and an interface 1502. The number of the processor 1501 can be one or more, and the number of the interface 1502 can be multiple.

Optionally, the chip further includes a memory 1503, and the memory 1503 is used to store necessary computer programs and data.

Those skilled in the art may also understand that the various illustrative logical blocks and steps listed in the embodiments of the present application may be implemented by electronic hardware, computer software, or a combination of the two. Whether such functions are implemented by hardware or software depends on the specific application and the design requirements of the entire system. Those skilled in the art may use various methods to implement the functions for each specific application, but such implementation should not be understood as exceeding the scope of protection of the embodiments of the present application.

The present application also provides a readable storage medium having instructions stored thereon, which implement the functions of any of the above method embodiments when executed by a computer.

The present application also provides a computer program product, which implements the functions of any of the above method embodiments when executed by a computer.

In the above embodiments, it can be implemented in whole or in part by software, hardware, firmware or any combination thereof. When implemented using software, it can be implemented in whole or in part in the form of a computer program product. The computer program product includes one or more computer programs. When the computer program is loaded and executed on a computer, the process or function according to the embodiment of the present application is generated in whole or in part. The computer can be a general-purpose computer, a dedicated computer, a computer network, or other programmable device. The computer program can be stored in a computer-readable storage medium, or transmitted from one computer-readable storage medium to another computer-readable storage medium. For example, the computer program can be transmitted from a website site, computer, server or data center by wired (e.g., coaxial cable, optical fiber, digital subscriber line (digital subscriber line, DSL)) or wireless (e.g., infrared, wireless, microwave, etc.) means to another website site, computer, server or data center. The computer-readable storage medium can be any available medium that can be accessed by a computer or a data storage device such as a server or data center that includes one or more available media integrated. The available media may be magnetic media (e.g., floppy disk, hard disk, tape), optical media (e.g., digital video disc (DVD)), or semiconductor media (e.g., solid state disk (SSD)), etc.

Those skilled in the art may understand that the various numerical numbers such as first and second involved in the present application are only used for the convenience of description and are not used to limit the scope of the embodiments of the present application, and also do not indicate the order of precedence.

At least one in the present application can also be described as one or more, and a plurality can be two, three, four or more, which is not limited in the present application. In the embodiments of the present application, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C” and “D”.

As used herein, the terms “machine-readable medium” and “computer-readable medium” refer to any computer program product, apparatus, and/or device (e.g., disk, optical disk, memory, programmable logic device (PLD)) for providing machine instructions and/or data to a programmable processor, including a machine-readable medium that receives machine instructions as a machine-readable signal. The term “machine-readable signal” refers to any signal for providing machine instructions and/or data to a programmable processor.

The systems and techniques described herein may be implemented in a computing system that includes back-end components (e.g., as a data server), or a computing system that includes middleware components (e.g., an application server), or a computing system that includes front-end components (e.g., a user computer with a graphical user interface or a web browser through which a user can interact with implementations of the systems and techniques described herein), or a computing system that includes any combination of such back-end components, middleware components, or front-end components. The components of the system may be interconnected by any form or medium of digital data communication (e.g., a communication network). Examples of communication networks include: a local area network (LAN), a wide area network (WAN), and the Internet.

A computer system may include clients and servers. Clients and servers are generally remote from each other and usually interact through a communication network. The relationship of client and server is generated by computer programs running on respective computers and having a client-server relationship to each other.

It should be understood that the various forms of processes shown above can be used to reorder, add or delete steps. For example, the steps recorded in this disclosure can be executed in parallel, sequentially or in different orders, as long as the desired results of the technical solutions disclosed in this disclosure can be achieved, and this document does not limit this.

In addition, it should be understood that the various embodiments of the present application may be implemented individually or in combination with other embodiments as long as the implementation is feasible.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Those skilled in the art can use different methods to implement the described functions for each specific application, but such implementation should not be considered to be beyond the scope of this application.

Those skilled in the art can clearly understand that, for the convenience and brevity of description, the specific operating processes of the systems, devices and units described above can refer to the corresponding processes in the aforementioned method embodiments and will not be repeated here.

The above are only specific implementations of the present application, but the protection scope of the present application is not limited thereto. Any skilled in the art can easily think of changes or substitutions within the technical scope disclosed in the present application, which should be included in the protection scope of the present application. Therefore, the protection scope of the present application should be based on the protection scope of the claims.

1. A method for managing IoT device, executed by an application function (AF) network element, and comprising:
receiving an Internet of Things (IoT) device management request sent by a user equipment (UE), wherein the IoT device management request comprises data for operating a location service (LCS) privacy profile of an IoT device in a unified data management (UDM) network element; and
sending the data and an operation message to the UDM network element through a network exposure function (NEF) network element, wherein the operation message is configured to notify the UDM network element to operate the LCS privacy profile according to the data.

2. The method according to claim 1, further comprising:
authenticating whether the UE is authorized to operate the LCS privacy profile;
wherein the sending the data and the operation message to the UDM network element through the NEF network element comprises:
sending the data and the operation message to the UDM network element through the NEF network element when the UE passes the authentication.

3. The method according to claim 2, wherein the data comprises: an ID of the UE and an ID of an IoT device that the UE expects to manage; and
the authenticating whether the UE is authorized to operate the LCS privacy profile comprises:
determining whether there is a binding relationship between the ID of the UE and the ID of the IoT device that the UE expects to manage; and
determining that the UE passes the authentication when the binding relationship exists.

4. The method according to claim 1, wherein the data comprises a user list expecting to locate the IoT device, and the operation message is further configured to notify the UDM network element to configure the LCS privacy profile to allow a user in the user list to locate the IoT device.

5. The method according to claim 4, wherein the IoT device management request further comprises an operation type, and wherein:
when the operation type is creation, the operation message is configured to notify the (UDM) network element to create an authorized user list in the LCS privacy profile, and the authorized user list includes user ID in the user list; or
when the operation type is add, the operation message is configured to notify the UDM network element to add the user ID in the user list to the authorized user list of the LCS privacy profile; or
when the operation type is deletion, the operation message is configured to notify the UDM network element to delete the user ID in the authorized user list of the LCS privacy profile except the user ID in the user list.

6. The method according to claim 1, wherein the data is associated with a valid time, and the valid time is configured to assist the UDM network element in deleting data in the LCS privacy configuration file whose storage time exceeds the valid time.

7. The method according to claim 1, further comprising:
receiving an operation response message sent by the UDM network element through the NEF network element, wherein the operation response message is configured to indicate whether the LCS privacy profile is successfully operated by the UDM, wherein:
when the operation response message indicates that the operation fails, a cause for failure is carried in the operation response message.

8. A method for managing IoT device, executed by a unified data management (UDM) network element, and comprising:
receiving, through a network exposure function (NEF) network element, data and an operation message sent by an application function (AF) network element for operating a location service (LCS) privacy profile of an IoT device in the UDM network element; and
operating the LCS privacy profile based on the data.

9. The method according to claim 8, wherein the data comprises a user list expecting to locate the IoT device, and operating the LCS privacy profile based on the data comprises:
configuring the LCS privacy profile to allow a user in the user list to locate the IoT device.

10. The method according to claim 8, wherein the configuring the LCS privacy profile to allow the user in the user list to locate the IoT device comprises at least one of:
when the authorized user list does not exist in the LCS privacy profile, creating an authorized user list in the LCS privacy profile, wherein the authorized user list comprises user ID in the user list;
when there is an authorized user list in the LCS privacy profile and the user list comprises a user ID that does not exist in the authorized user list, adding the user ID that does not exist in the authorized user list to the authorized user list; or
when there is an authorized user list in the LCS privacy profile and the authorized user list comprises a user ID that is not indicated in the user list, deleting the user ID that is not indicated in the user list from the authorized user list.

11. The method according to claim 8, further comprising:
deleting data in the LCS privacy profile whose storage time exceeds an effective time, wherein the data is associated with the effective time.

12. The method according to claim 8, further comprising:
sending an operation response message, wherein the operation response message is configured to indicate whether the LCS privacy profile is successfully operated by the UDM, wherein:
when the operation response message indicates that the operation fails, a cause for failure is carried in the operation response message.

13. A method for managing Internet of Things device, executed by a user equipment (UE), and comprising:
sending an Internet of Things (IoT) device management request, wherein the IoT device management request comprises data for operating a location service (LCS) privacy profile of an IoT device in a unified data management (UDM) network element.

14. The method according to claim 13, wherein the data comprises an ID of the UE, an ID of an IoT device that the UE expects to manage, and a user list expecting to locate the IoT device.

15. The method according to claim 13, further comprising:
receiving an IoT device management response message, wherein the IoT device management response message is configured to indicate whether the LCS privacy profile is successfully operated by the UDM, wherein:
when the IoT device management response message indicates that the operation fails, a cause for failure is carried in the operation response message.

16. (canceled)

17. An apparatus for managing IoT device, comprising:
a memory;
a transceiver; and
a processor coupled to the memory and the transceiver, and configured to perform the method according to claim 1.

18. An apparatus for managing IoT device, comprising:
a memory;
a transceiver; and
a processor coupled to the memory and the transceiver, and configured to perform the method according to claim 8.

19. An apparatus for managing IoT device, comprising:
a memory;
a transceiver; and
a processor coupled to the memory and the transceiver, and configured to perform the method according to claim 13.

20. (canceled)

21. (canceled)

22. A non-transitory computer storage medium storing computer executable instructions, that when executed by a processor, cause the processor to perform the method according to claim 1.

23. A non-transitory computer storage medium storing computer executable instructions, that when executed by a processor, cause the processor to perform the method according to claim 8.
